(19) United States
(12) Patent Application Publication
(10) Pub. No.: US 2026/0030600 A1
(43) Pub. Date: Jan. 29, 2026

(54) RECOMMENDED CONTENT GENERATION METHOD, AN APPARATUS, DEVICE, READABLE STORAGE MEDIUM, AND PRODUCT

(71) Applicant: DOUYIN VISION CO., LTD., Shijingshan District, Beijing (CN)

(72) Inventors: Chuanqi Jing, Beijing (CN); Xingwen Zhang, Beijing (CN); Dongling Gao, Beijing (CN)

(21) Appl. No.: 19/056,299

(22) Filed: Feb. 18, 2025

(30) Foreign Application Priority Data
Jul. 24, 2024 (CN) 202411001614.1

(51) Int. Cl. G06Q 50/00; G06T 11/60; G06V 20/70

(52) U.S. Cl. CPC G06Q 50/01; G06T 11/60; G06V 20/70

(57) ABSTRACT

Embodiments of the present disclosure provide a recommended content generation method, an apparatus, a device, a readable storage medium, and a product. The method includes: determining at least one piece of media content to be recommended; obtaining, for each piece of media content, basic information corresponding to the piece of media content, and obtaining at least one type of interactive content generated based on the piece of media content; generating, based on the basic information corresponding to each piece of media content and the at least one type of interactive content, recommended content corresponding to the piece of media content, wherein the recommended content includes a recommended image and a recommended text; and generating target recommended content based on the recommended content corresponding to each piece of media content, and posting the target recommended content.

### CROSS-REFERENCE TO RELATED APPLICATION(S)

This application claims priority to Chinese Application No. 202411001614.1 filed in Jul. 24, 2024, the disclosures of which are incorporated herein by reference in their entireties.

### FIELD

Embodiments of the present disclosure relate to the field of data processing technologies, and in particular, to a recommended content generation method, an apparatus, a device, a readable storage medium, and a product.

### BACKGROUND

When browsing media content in application software, a user may perform a content recommendation operation on media content of interest.

In the related art, a user may write a recommended text based on a currently selected media content to be recommended, and determine a recommended picture.

### SUMMARY

Embodiments of the present disclosure provide a recommended content generation method, an apparatus, a device, a readable storage medium, and a product, to solve the current technical problem of high difficulty in generating recommended content for media content.

According to a first aspect, an embodiment of the present disclosure provides a recommended content generation method. The method includes:
determining at least one piece of media content to be recommended;
obtaining, for each piece of media content, basic information corresponding to the piece of media content, and obtaining at least one type of interactive content generated based on the piece of media content;
generating, based on the basic information corresponding to each piece of media content and the at least one type of interactive content, recommended content corresponding to the piece of media content, wherein the recommended content includes a recommended image and a recommended text; and
generating target recommended content based on the recommended content corresponding to each piece of media content, and posting the target recommended content.

According to a second aspect, an embodiment of the present disclosure provides a recommended content generation apparatus. The apparatus includes:
a determination module configured to determine at least one piece of media content to be recommended;
an obtaining module configured to obtain, for each piece of media content, basic information corresponding to the piece of media content, and obtain at least one type of interactive content generated based on the piece of media content;
a processing module configured to generate, based on the basic information corresponding to each piece of media content and the at least one type of interactive content, recommended content corresponding to the piece of media content, wherein the recommended content includes a recommended image and a recommended text; and
a generation module configured to generate target recommended content based on the recommended content corresponding to each piece of media content, and post the target recommended content.

According to a third aspect, an embodiment of the present disclosure provides an electronic device. The electronic device includes: a processor and a memory, where
the memory stores computer-executable instructions; and
the processor executes the computer-executable instructions stored in the memory, to cause the at least one processor to perform the recommended content generation method according to the first aspect and various possible designs of the first aspect.

According to a fourth aspect, an embodiment of the present disclosure provides a computer-readable storage medium. The computer-readable storage medium has stored therein computer-executable instructions that, when executed by a processor, cause the recommended content generation method according to the first aspect and various possible designs of the first aspect to be implemented.

According to a fifth aspect, an embodiment of the present disclosure provides a computer program product including a computer program. When the computer program is executed by a processor, the recommended content generation method according to the first aspect and various possible designs of the first aspect is implemented.

According to the recommended content generation method, the apparatus, the device, the readable storage medium and the product provided in the embodiments, after the at least one piece of media content to be recommended is determined, the basic information corresponding to each of the at least one piece of media content and the at least one type of interactive content generated based on the piece of media content are obtained, so that the recommended content corresponding to the piece of media content can be automatically generated based on the basic information and the at least one type of interactive content. Further, the target media content can be generated and posted based on the corresponding recommended content associated with the at least one piece of media content.

### BRIEF DESCRIPTION OF THE DRAWINGS

In order to describe the technical solutions in embodiments of the present disclosure or in the prior art more clearly, the accompanying drawings for describing the embodiments or the prior art will be briefly described below. Apparently, the accompanying drawings in the description below show some embodiments of the present disclosure, and those of ordinary skill in the art may still derive other accompanying drawings from these accompanying drawings without creative efforts.

FIG. 1 is a schematic flowchart of a recommended content generation method according to an embodiment of the present disclosure;

FIG. 2 is a schematic diagram of target recommended content according to an embodiment of the present disclosure;

FIG. 3 is a schematic flowchart of a recommended content generation method according to another embodiment of the present disclosure;

FIG. 4 is a schematic flowchart of a recommended content generation method according to another embodiment of the present disclosure;

FIG. 5 is a schematic flowchart of a recommended content generation method according to another embodiment of the present disclosure;

FIG. 6 is a schematic diagram of another piece of target recommended content according to an embodiment of the present disclosure;

FIG. 7 is a schematic diagram of a structure of a recommended content generation apparatus according to an embodiment of the present disclosure; and

FIG. 8 is a schematic diagram of a structure of an electronic device according to an embodiment of the present disclosure.

### DETAILED DESCRIPTION OF EMBODIMENTS

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

When browsing media content in application software, a user may perform a content recommendation operation on media content of interest.

In the related art, a user may write a recommended text based on a currently selected media content to be recommended, and determine a recommended picture. However, it is often difficult and time-consuming to generate recommended content using the above method to recommend media content, and the quality of the generated recommended content is relatively dependent on the writing level of the user. Therefore, the recommended content generated using the above method often has poor content quality.

To solve the current technical problem of high difficulty in generating recommended content for media content, the present disclosure provides a recommended content generation method, an apparatus, a device, a readable storage medium, and a product.

According to the recommended content generation method, the apparatus, the device, the readable storage medium and the product provided in the embodiments, after the at least one piece of media content to be recommended is determined, the basic information corresponding to each of the at least one piece of media content and the at least one type of interactive content generated based on the piece of media content are obtained, so that the recommended content corresponding to the piece of media content can be automatically generated based on the basic information and the at least one type of interactive content. Further, the target media content can be generated and posted based on the corresponding recommended content associated with the at least one piece of media content. Therefore, target recommended content highlighting the characteristics of each piece of media content can be automatically generated without the need for a user to manually determine a recommended image and write a recommended text, thereby reducing the difficulty in generating the target recommended content and improving the content quality of the target recommended content.

Specifically, target recommended content can be automatically generated as long as a user determines at least one piece of media content to be recommended, instead of manually writing a recommended text and editing a recommended image, thereby effectively reducing the difficulty in generating target recommended content. In addition, since recommended content associated with media content is generated based on the basic information associated with the piece of media content and the interactive content, the recommended content not only includes the basic information of the piece of media content, but also includes personalized content generated based on the interactive content and capable of highlighting characteristics of the piece of media content. Further, after the target recommended content is posted, viewers of the target recommended content can more effectively select, based on the target recommended content, media content that better meets their actual needs.

It should be noted that the recommended content generation method, the apparatus, the device, the readable storage medium, and the product provided in the present disclosure may be applied in any media content recommendation scenario.

With the gradual development of terminal technology, more and more application software has gradually come into life of users. For example, a user may listen to and read books in a book application, and may browse video media content in a video application, etc. When browsing media content, a user may perform a recommendation operation on favorite media content.

In the related art, a user needs to manually generate a recommended image associated with media content and to manually write a recommended text associated with the piece of media content. Therefore, a content recommendation operation is often cumbersome and difficult.

In the process of solving the above technical problem, the inventors have found through research that, to quickly generate target recommended content associated with media content, an image generation model and a text generation model may be pre-constructed. After at least one piece of media content currently selected by a user is determined, basic information corresponding to the piece of media content and at least one type of interactive content generated for the piece of media content may be obtained, so that recommended content associated with the piece of media content to be recommended can be automatically generated based on the basic information and the interactive content, wherein the recommended content may include a recommended image and a recommended text. Further, target recommended content can be automatically generated based on a recommended image and a recommended text corresponding to each of the at least one piece of media content to be recommended.

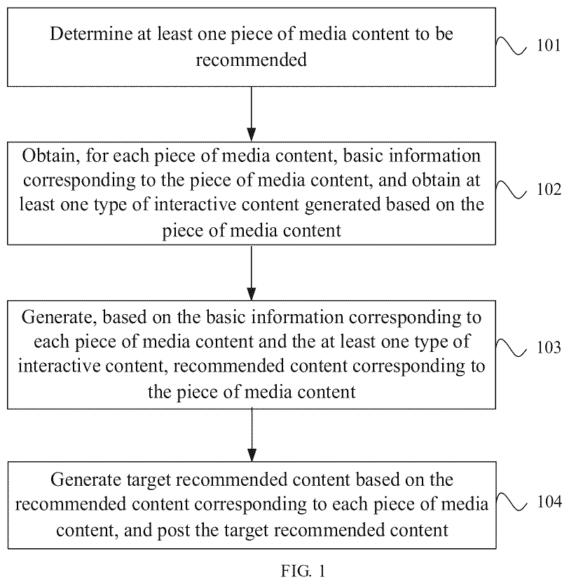

FIG. 1 is a schematic flowchart of a recommended content generation method according to an embodiment of the present disclosure. As shown in FIG. 1, the method includes the following steps.

Step 101: Determine at least one piece of media content to be recommended.

An executing body of this embodiment is a recommended content generation apparatus. The recommended content generation apparatus may be coupled to a terminal device, so that a recommended image and a recommended text corresponding to at least one piece of media content can be automatically generated based on a content recommendation operation triggered in the terminal device by a user. Target recommended content is generated based on the recommended image and the recommended text corresponding to the at least one piece of media content.

Alternatively, the recommended content generation apparatus may be coupled to a server communicatively connected to the terminal device. The server may obtain a content recommendation instruction sent by the terminal device, and generate, based on the content recommendation instruction, a recommended image and a recommended text corresponding to the at least one piece of media content. Target recommended content is generated based on the recommended image and the recommended text corresponding to the at least one piece of media content. The target recommended content is sent to the terminal device for display.

In this implementation, the user may browse media content in a target application. The media content includes, but is not limited to, book media content, video media content, audio media content, etc. The user may also perform a recommendation operation on favorite media content. To implement a recommendation operation on media content, at least one piece of media content to be recommended may be determined.

Optionally, a recommendation control may be preset. The user may initiate a content recommendation operation by triggering the recommendation control. In response to the content recommendation operation triggered by the user, a content recommendation page may be displayed. A recommended content selection control may be provided in the content recommendation page. In response to a trigger operation of the user on the recommended content selection control, at least one piece of media content currently available for recommendation may be displayed. The at least one piece of media content may be media content that the user has historically viewed, or may be media content that the user has historically interacted with, etc., which is not limited in the present disclosure. In response to a selection operation triggered by the user for at least one piece of media content, the at least one piece of media content currently selected by the user may be determined as at least one piece of media content to be recommended.

Step 102: Obtain, for each piece of media content, basic information corresponding to the piece of media content, and obtain at least one type of interactive content generated based on the piece of media content.

In this implementation, to be able to automatically generate target recommended content based on at least one piece of media content, basic information corresponding to the piece of media content needs to be obtained first. The basic information includes, but is not limited to, classification information, creator information, identification information, introduction information, image information, etc. Taking the media content being book media content as an example, the basic information includes a book title, book classification information, author information, number of readers, book introduction information, a book cover, etc. of the book media content.

In addition, to generate personalized content capable of highlighting characteristics of media content, at least one type of interactive content generated based on the media content may further be obtained. The interactive information includes, but is not limited to, content marking data generated by historical users based on the media content, review information posted by the users for the media content, etc. Still taking the media content being book media content as an example, the interactive content includes, but is not limited to, review information posted by historical users based on the media content and marking content added by the users for paragraphs in the book media content.

Step 103: Generate, based on the basic information corresponding to each piece of media content and the at least one type of interactive content, recommended content corresponding to the piece of media content, wherein the recommended content includes a recommended image and a recommended text.

In this embodiment, after basic information corresponding to the piece of media content and at least one type of interactive content are separately obtained, recommended content corresponding to the piece of media content may be generated based on the basic information corresponding to the piece of media content and the at least one type of interactive content, wherein the recommended content includes a recommended image and a recommended text.

Optionally, a recommended image corresponding to the piece of media content may be generated based on the basic information. A recommended text may be generated based on the recommendation information and the at least one type of interactive information.

Step 104: Generate target recommended content based on the recommended content corresponding to each piece of media content, and post the target recommended content.

In this implementation, after the recommended image and the recommended text corresponding to each piece of media content are separately obtained, target recommended content may be generated based on the recommended image and the recommended text associated with the at least one piece of media content, and the target recommended content is posted.

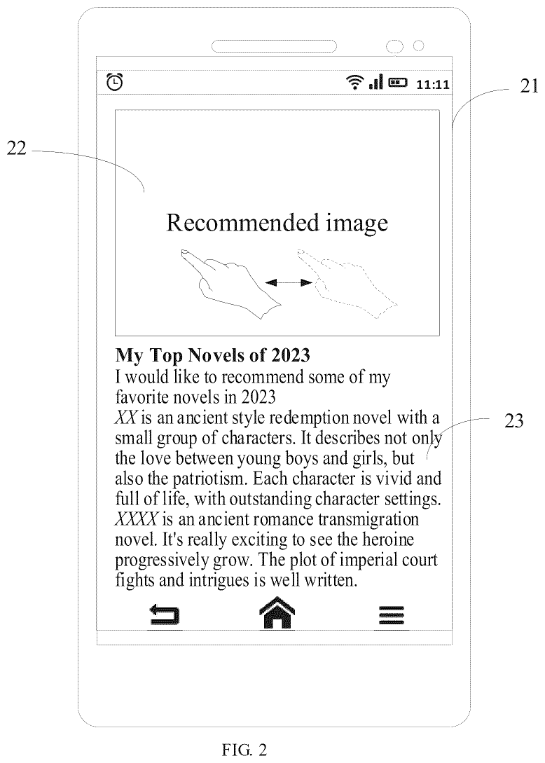

FIG. 2 is a schematic diagram of target recommended content according to an embodiment of the present disclosure. As shown in FIG. 2, the target recommended content 21 may include at least one recommended image 22, and a recommended text 23 corresponding to at least one piece of media content. A user may implement switched viewing of different recommended images 22 through a sliding operation triggered in the region of the recommended images 22.

According to the recommended content generation method provided in this embodiment, after the at least one piece of media content to be recommended is determined, the basic information corresponding to the piece of media content and the at least one type of interactive content generated based on the piece of media content are obtained, so that the recommended content corresponding to the piece of media content can be automatically generated based on the basic information and the at least one type of interactive content. Further, the target media content can be generated and posted based on the corresponding recommended content associated with the at least one piece of media content. Target recommended content can be automatically generated as long as the user determines at least one piece of media content to be recommended, instead of manually writing a recommended text and editing a recommended image, thereby effectively reducing the difficulty in generating target recommended content. In addition, since recommended content associated with media content is generated based on the basic information associated with the piece of media content and the interactive content, the recommended content not only includes the basic information of the piece of media content, but also includes personalized content generated based on the interactive content and capable of highlighting characteristics of the piece of media content. Further, after the target recommended content is posted, viewers of the target recommended content can more effectively select, based on the target recommended content, media content that better meets their actual needs.

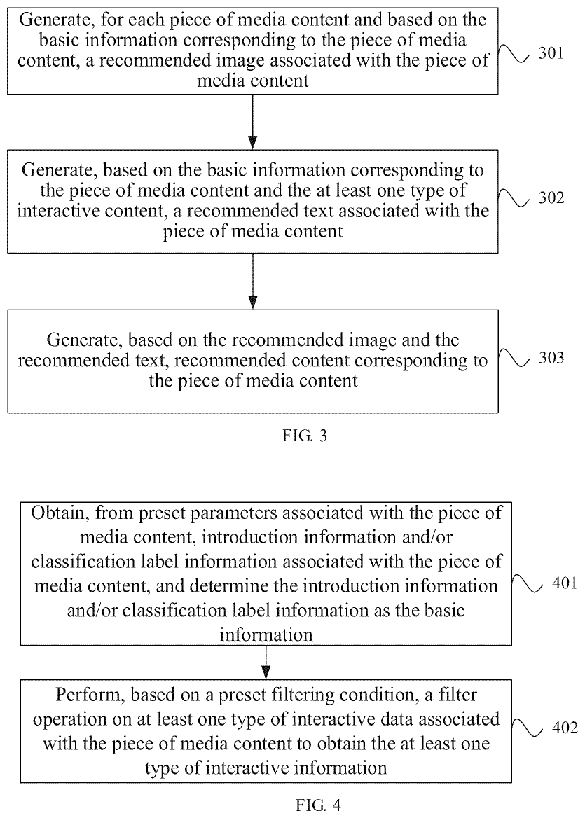

FIG. 3 is a schematic flowchart of a recommended content generation method according to another embodiment of the present disclosure. On the basis of any one of the above embodiments, as shown in FIG. 3, step 103 includes the steps as follows:

Step 301: Generate, for each piece of media content and based on the basic information corresponding to the piece of media content, a recommended image associated with the piece of media content.

Step 302: Generate, based on the basic information corresponding to the piece of media content and the at least one type of interactive content, a recommended text associated with the piece of media content.

Step 303: Generate, based on the recommended image and the recommended text, recommended content corresponding to the piece of media content.

In this embodiment, to implement an effective recommendation operation on at least one piece of media content selected currently, a recommended image for the piece of media content may be generated. Image information, introduction information, category information, etc. associated with the piece of media content are displayed in the recommended image.

Optionally, after the basic information corresponding to the piece pf media content is obtained, the content-associated recommended image may be generated based on the basic information. The recommended text associated with the piece of media content is generated based on the basic information corresponding to the piece of media content and the at least one type of interactive content. After the recommended image and the recommended text corresponding to each piece of media content are separately obtained, an aggregation operation may be performed on the recommended image and the recommended text associated with the at least one piece of media content to generate target recommended content.

Further, on the basis of any one of the above embodiments, step 102 includes:
obtaining the basic information from preset parameters associated with the piece of media content, wherein the basic information includes one or more of a content title, a content parameter, introduction information, and a cover image; and
step 201:
inputting the basic information into a predetermined image generation model to obtain a recommended image output by the image generation model, wherein the recommended image includes one or more of the content title, the content parameter, the introduction information, and the cover image, and a color of the recommended image matches that of the cover image.

In this embodiment, each piece of media content corresponds to a pre-stored preset parameter, wherein the preset parameters include basic parameters such as a content title, a content parameter, introduction information, etc. The basic information is obtained from preset parameters associated with the piece of media content, wherein the basic information includes one or more of a content title, a content parameter, introduction information, and a cover image.

Further, an image generation model may be predetermined. The image generation model may be obtained by iterative training using a preset training dataset. The training dataset includes at least one group of training data, and each group of training data includes at least one type of basic information associated with preset media content and a recommended image associated with the preset media content. After model training is performed through the training dataset, the image generation model can quickly and accurately generate a recommended image based on the at least one type of basic information associated with the piece of media content.

Therefore, after basic information corresponding to the piece of media content is obtained, the basic information may be input into the predetermined image generation model, to obtain a recommended image output by the image generation model, wherein the recommended image includes one or more of a content title, a content parameter, introduction information, and a cover image. To improve the display effect of the recommended image and make the overall color of the recommended image more harmonious, the color of the recommended image matches that of the cover image,

According to the recommended content generation method provided in this embodiment, the image generation model is predetermined, so that after the basic information corresponding to the piece of media content is captured, the basic information can be automatically input into the image generation model, to obtain the recommended image output by the image generation model. Therefore, the efficiency and accuracy of generation of the recommended image are improved.

Further, on the basis of any one of the above embodiments, step 202 includes:
inputting, for each piece of media content, the basic information associated with the piece of media content and the at least one type of interactive content into a predetermined text generation model, to obtain a recommended text generated by the text generation model.

In this embodiment, a text generation model may be predetermined. The text generation model may be obtained by iterative training using a preset training dataset. The training dataset includes at least one group of training data, and each group of training data includes at least one type of basic information and at least one type of interactive information associated with preset media content, and a recommended text associated with the preset media content. After model training is performed through the training dataset, the text generation model can quickly and accurately generate a recommended text based on the at least one type of basic information and the at least one type of interactive information associated with the piece of media content.

Therefore, after the basic information corresponding to the piece of media content and the at least one type of interactive content are obtained, the basic information and the at least one type of interactive content may be input into the predetermined text generation model to obtain a recommended text corresponding to the piece of media content.

According to the recommended content generation method provided in this embodiment, the text generation model is predetermined, so that the recommended text can be automatically generated based on the text generation model, the basic information associated with the piece of media content, and the at least one type of interactive content, without the need for the user to write the recommended text. In addition, since the recommended text is generated based on the basic information associated with the piece of media content and the interactive content, the recommended text not only includes the basic information of the piece of media content, but also includes personalized content generated based on the interactive content and capable of highlighting characteristics of the piece of media content.

Optionally, on the basis of any one of the above embodiments, after step 103, the method further includes:
obtaining content of editing determined by the user based on the recommended content; and
performing an editing operation on the recommended content based on the content of editing to obtain edited recommended content.

Step 104 includes:
generating the target recommended content based on each piece of edited recommended content.

In this embodiment, after the recommended content is generated, the user may further adjust the recommended content according to actual needs, to obtain recommended content that better meets the personalized needs of the user.

Optionally, after the recommended content is generated, the user may further perform the editing operation on the recommended content. The content of editing determined by the user based on the recommended content may be obtained. The content of editing includes, but is not limited to, adding content, deleting content, adjusting the order of sentences in the recommended text, modifying content, etc.

After the content of editing is obtained, the editing operation may be performed on the recommended content based on the content of editing to obtain edited recommended content. Then, target recommended content is generated based on the edited recommended content associated with the at least one piece of media content.

According to the recommended content generation method provided in this embodiment, the recommended content is edited based on the content of editing determined by the user, so that the finally generated target recommended content can better meet the personalized needs of the user, and the content quality of the target recommended content can be improved.

FIG. 4 is a schematic flowchart of a recommended content generation method according to another embodiment of the present disclosure. On the basis of any one of the above embodiments, as shown in FIG. 4, step 102 includes the steps as follows:

Step 401: Obtain, from preset parameters associated with the piece of media content, introduction information and/or classification label information associated with the piece of media content, and determine the introduction information and/or classification label information as the basic information.

Step 402: Perform, based on a preset filtering condition, a filter operation on at least one type of interactive data associated with the piece of media content to obtain the at least one type of interactive information.

In this embodiment, to be able to generate a more accurate recommended text, at least one type of basic information associated with the piece of media content and at least one type of interactive information may be obtained.

Optionally, at least one type of basic information may be obtained from preset parameters associated with the piece of media content, wherein the basic information includes introduction information and/or classification label information associated with the piece of media content.

Further, when browsing media content, the user may generate interactive information for the media content. Taking the media content being book media content as an example, the interactive information includes, but is not limited to, underline markings made by the user for some segments in the book media content and comment content posted by the user for the book media content, etc. To obtain more effective interactive information, a filtering condition may be preset, and a filter operation may be performed, based on the preset filtering condition, on at least one type of interactive data associated with the piece of media content to obtain the at least one type of interactive information.

According to the recommended content generation method provided in this embodiment, the at least one type of basic information corresponding to the piece of media content and the interactive information corresponding to the piece of media content are obtained, so that more diversified second associated information can be obtained. Further, a recommended text with richer content and higher quality can be automatically generated based on the second associated information.

Optionally, on the basis of any one of the above embodiments, the interactive data includes at least one piece of content marking data generated by the user for at least part of the piece of media content. Step 402 includes:
determining a number of historical views corresponding to each piece of content marking data; and
determining, as the interactive information, a piece of content marking data having a number of historical views greater than a preset number threshold from the at least one piece of content marking data.

In this embodiment, when the user browses media content, at least one piece of content marking data may be generated for at least part of the piece of media content. Taking the media content being book media content as an example, the content marking data may be marking data obtained by the user underlining some sentences in the book media content. Taking the media content being video media content as an example, the content marking data may be marking data such as bullet comments, comments, and saves posted by the user for a video segment in the video media content.

To obtain higher-quality content from at least one piece of content marking data historically generated by the user, a number of historical views corresponding to each piece of content marking data may be determined. A piece of content marking data having a number of historical views greater than a preset number threshold from the at least one piece of content marking data is determined as interactive information.

For example, a sorting operation may be performed on the at least one piece of content marking data based on a descending order of the numbers of historical views from the at least one piece of content marking data. The first ten pieces of content marking data sorted higher are determined as interactive information.

According to the recommended content generation method provided in this embodiment, the piece of content marking data having a number of historical views greater than a preset number threshold from content marking data historically generated by the user is determined as the interactive information, so that highlighted content in the piece of media content can be filtered, and further, a recommended text more accurately describing the piece of media content can be generated based on the interactive information.

Optionally, on the basis of any one of the above embodiments, the interactive data includes a plurality of pieces of image and text review data posted by a plurality of historical users for the piece of media content. Step 402 includes:
performing, by using a predetermined text recognition model, a filter operation on a plurality pieces of image and text review data satisfying a first preset condition in the interactive data to obtain a plurality of pieces of first interactive data, wherein the first preset condition includes an amount of data included in the image and text review data satisfying a preset data amount condition, and the image and text review data does not include negative emotional content;
determining an association parameter corresponding to each piece of first interactive data, and performing a filter operation on the plurality of pieces of first interactive data based on a preset interaction condition and the association parameter to obtain a plurality of pieces of second interactive data, wherein the association parameter includes data amount information, an interaction parameter, and a browsing parameter of the first interactive data; and
performing a filter operation on the plurality of pieces of second interactive data by using a preset filtering word set to obtain the interactive information.

In this embodiment, when browsing media content, the user may post image and text review data for the media content. Taking the media content being book media content as an example, the user may post, for the book media content, review content such as “rich content, tight rhythm, and outstanding character settings”. Therefore, high-quality content may be filtered from the image and text review data to generate a recommended text.

Optionally, a filter operation may be performed, by using a predetermined text recognition model, on a plurality pieces of image and text review data satisfying a first preset condition in the interactive data to obtain a plurality of pieces of first interactive data, wherein the first preset condition includes an amount of data included in the image and text review data satisfying a preset data amount condition, and the image and text review data does not include negative emotional content; taking the media content being book media content as an example, the first preset condition may be to select, from the image and text review data, 20 non-negative emotional and informative comments as interactive information.

Further, the interaction condition may be preset. An association parameter corresponding to each piece of first interactive data may be determined, and a filter operation is performed on the plurality of pieces of first interactive data based on the preset interaction condition and the association parameter to obtain a plurality of pieces of second interactive data, wherein the association parameter includes data amount information, an interaction parameter, and a browsing parameter of the first interactive data. Taking the media content being book media content as an example, the interaction condition may be to select, from the first interactive data, an image and text comment with more than 30 words, more than 3 likes, at least one reply, and a user reading time of more than one hour as second interactive data.

Since second interactive data historically posted by the user is relatively rich in content, a filtering word set may be preset to perform a further filter operation on the second interactive data to obtain interactive information.

Further, on the basis of any one of the above embodiments, the filtering word set includes a positive word subset and a negative word subset.

Performing the filter operation on the plurality of pieces of second interactive data by using the preset filtering word set to obtain the interactive information includes:
performing a filtering-out operation on pieces of second interactive data including a word in the negative word subset in the plurality of pieces of second interactive data to obtain a plurality of pieces of filtered second interactive data; and
determining, as the interactive information, a piece of second interactive data including a word in the positive word subset in the plurality of pieces of filtered second interactive data.

In this embodiment, since second interactive data historically posted by the user is relatively rich in content, a filtering word set may be preset to perform a further filter operation on the second interactive data.

Taking the media content being book media content in a state of being updated as an example, reviews posted by users for the book media content includes, but are not limited to, negative reviews such as slow updates, weak ending, poor wording, lack of substantial content, giving up reading, etc.; or may include positive reviews such as good writing, tightly plotted, highly recommended, and interesting.

To implement the generation of a recommended text for media content, a negative word subset and a positive word subset may be preset. The negative word subset and the positive word subset are used to perform a further filter operation on second interactive data. The negative word subset includes negative words such as slow updates, weak ending, poor wording, lack of substantial content, slow development, repeated content, giving up reading, etc., and the positive word subset includes positive words such as good writing, tightly plotted, highly recommended, interesting, substantial content, and outstanding characters. The user may also perform operations, such as updating, adjustment, on words in the negative word subset and the positive word subset according to actual needs, which is not limited in the present disclosure.

Optionally, a filtering-out operation may be performed on second interactive data including a word in the negative word subset in the plurality of pieces of second interactive data to obtain a plurality of pieces of filtered second interactive data. A plurality of pieces of second interactive data including a word in the negative word subset in the second interactive data may be determined, and a filtering-out operation may be performed on the plurality of pieces of second interactive data. A piece of second interactive data including a word in the positive word subset in the plurality of pieces of filtered second interactive data may be determined as interactive information. A piece of second interactive data including a word in the positive word subset in the plurality of pieces of filtered second interactive data may be determined, some of the plurality of pieces of second interactive data are retained, and the other pieces of second interactive data are filtered to obtain interactive information.

According to the recommended content generation method provided in this embodiment, the filter operation is performed on the plurality of pieces of image and text review data posted by the historical users on the piece of media content to obtain the interactive information, so that interactive information capable of accurately describing the piece of media content can be obtained. Further, a more accurate recommended text can be generated based on the interactive information.

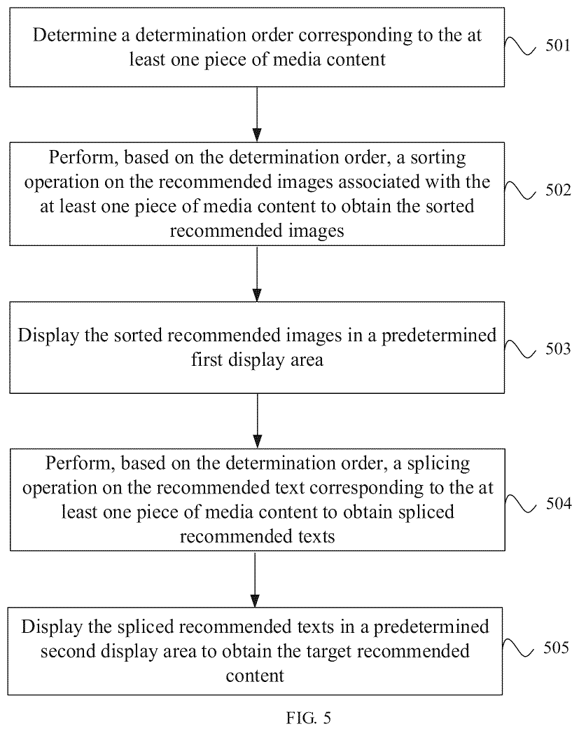

FIG. 5 is a schematic flowchart of a recommended content generation method according to another embodiment of the present disclosure. On the basis of any one of the above embodiments, as shown in FIG. 5, step 104 includes the steps as follows:

Step 501: Determine a determination order corresponding to the at least one piece of media content.

Step 502: Perform, based on the determination order, a sorting operation on the recommended images associated with the at least one piece of media content to obtain the sorted recommended images.

Step 503: Display the sorted recommended images in a predetermined first display area.

Step 504: Perform, based on the determination order, a splicing operation on the recommended text corresponding to the at least one piece of media content to obtain spliced recommended texts.

Step 505: Display the spliced recommended texts in a predetermined second display area to obtain the target recommended content.

In this embodiment, after the recommended image and the recommended text associated with at least one piece of media content are generated respectively, target recommended content may be generated based on the recommended image and the recommended text associated with the at least one piece of media content.

Optionally, it may be determined that a user determines a determination order corresponding to at least one piece of media content. A sorting operation may be performed based on the determination order on the recommended image associated with the at least one piece of media content to obtain the sorted recommended image. The sorted recommended image may be displayed in a stacked way. The user may view different recommended images through a sliding operation in a preset direction. Alternatively, the at least one recommended image may be spliced into a same image according to the determination order, so that the user can view a plurality of recommended images on the same image. This is not limited in the present disclosure.

Further, a splicing operation may be performed on the recommended texts corresponding to the at least one piece of media content based on the determination order to obtain spliced recommended texts. Since the spliced recommended text is relatively long, the user may view all of the recommended texts through a sliding operation.

Optionally, the sorted recommended image may be displayed in a predetermined first display area; and the spliced recommended texts may be displayed in a predetermined second display area to obtain the target recommended content. The first display area and the second display area may be arranged longitudinally, or the first display area and the second display area may be arranged transversely. This is not limited in the present disclosure. In addition, the user may further adjust a display size and a display position of the first display area and the second display area according to actual needs, which is not limited in the present disclosure.

According to the recommended content generation method provided in this embodiment, the recommended images are sorted according to the determination order corresponding to the at least one piece of media content, and the recommended texts are spliced, so that the user can sequentially browse the recommended images and the recommended texts associated with the plurality of pieces of media content in the target recommended content. Moreover, more recommended content can be displayed in a limited display page.

Further, on the basis of any one of the above embodiments, after step 104, the method further includes:
displaying, in a display area associated with each of recommended images, a trigger control corresponding to the piece of media content associated with the recommended image, wherein the trigger control is configured to display the piece of media content in response to a trigger operation of the user after the target recommended content is posted.

In this embodiment, after the target recommended content is posted, to facilitate the user to view at least one piece of media content in the target recommended content, a trigger control associated with the piece of media content may be added to the target recommended content.

Optionally, after the sorting operation is performed on the recommended images corresponding to the at least one piece of media content based on the determination order, for each recommended image associated with the piece of media content, a trigger control corresponding to the piece of media content may be displayed in a display area associated with the recommended image. To prevent the trigger control from blocking the recommended image, the trigger control may be displayed in an edge area such as a lower left corner of the recommended image. Alternatively, the user may also adjust the display position of the trigger control according to actual needs, which is not limited in the present disclosure.

Therefore, after the target recommended content is posted, if another user is interested in a certain piece of media content when browsing the target recommended content, the another user may view the piece of media content by triggering the trigger operation associated with the piece of media content.

According to the recommended content generation method provided in this embodiment, the trigger control corresponding to the piece of media content associated with the recommended image may be displayed in the display area associated with each of the recommended images, so that the user can quickly view media content of interest in the process of browsing the target recommended content, thereby improving the efficiency of content recommendation.

Further, on the basis of any one of the above embodiments, after performing, based on the determination order, the splicing operation on the recommended text corresponding to the at least one piece of media content to obtain the spliced recommended texts, the method further includes:
displaying, for a recommended text corresponding to each piece of media content in the spliced recommended texts, a trigger control corresponding to the piece of media content in a display area associated with the recommended text, wherein the trigger control is configured to display the piece of media content in response to a trigger operation of the user after the target recommended content is posted.

In this embodiment, after the target recommended content is posted, to facilitate the user to view at least one piece of media content in the target recommended content, a trigger control associated with the piece of media content may be added to the target recommended content.

Optionally, after the splicing operation is performed on recommended texts corresponding to at least one piece of media content based on the determination order, to obtain spliced recommended texts, for the recommended text associated with each piece of media content, the trigger control corresponding to the piece of media content may be displayed in a display area associated with the recommended text. Therefore, after the target recommended content is posted, if another user is interested in a certain piece of media content when browsing the target recommended content, the another user may view the piece of media content by triggering a trigger operation associated with the piece of media content.

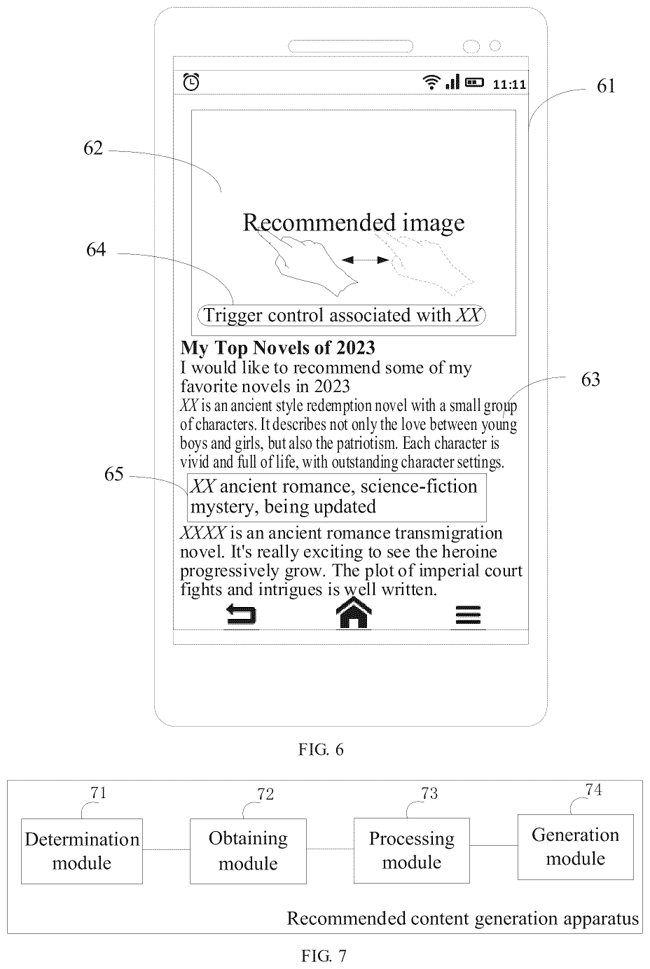

FIG. 6 is a schematic diagram of another piece of target recommended content according to an embodiment of the present disclosure. As shown in FIG. 6, target recommended content 61 may include at least one recommended image 62 arranged in a determination order, and a recommended text 63 corresponding to at least one piece of media content and spliced in a determination order. A trigger control 64 corresponding to the piece of media content associated with the recommended image 62 may be displayed in a display area associated with each of the recommended images. A trigger control 65 corresponding to the piece of media content is displayed in a display area associated with the recommended text 63. Therefore, a user can view media content by triggering the trigger control corresponding to the piece of media content.

According to the recommended content generation method provided in this embodiment, for a recommended text corresponding to each piece of media content in the spliced recommended texts, a trigger control corresponding to the piece of media content is displayed in a display area associated with the recommended text, so that the user can quickly view media content of interest in the process of browsing the target recommended content, thereby improving the efficiency of content recommendation.

Further, on the basis of any one of the above embodiments, the method further includes:
obtaining a target image determined by a user; and
displaying the target image before the sorted recommended image.

In this embodiment, the user may set the first image in target recommended content according to actual needs.

Optionally, a target image determined by a user may be obtained. The target image may be captured by the user in real time, or may be obtained by the user in a preset storage path, which is not limited in the present disclosure.

After recommended images corresponding to the at least one piece of media content is sorted, the target image may be displayed before the sorted recommended image. Therefore, after the target recommended content is posted, the target image determined by the user may be the first image corresponding to the target recommended content. The user may view the recommended image corresponding to the at least one piece of media content through a switching operation.

According to the recommended content generation method provided in this embodiment, the target image determined by the user is used as the first image before all the recommended images, so that the display style of the target recommended content can be enriched, the target recommended content can better meet the personalized needs of the user, and the user experience can be improved.

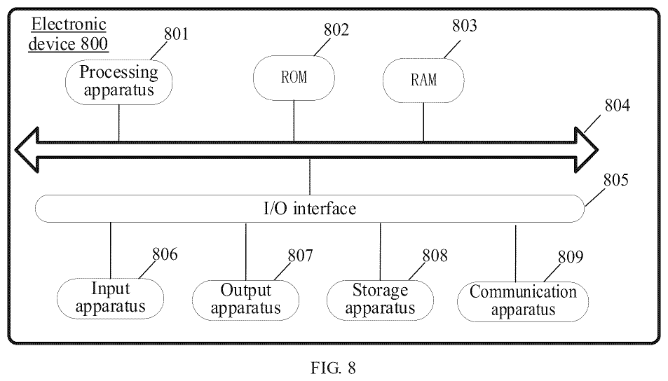

FIG. 7 is a schematic diagram of a structure of a recommended content generation apparatus according to an embodiment of the present disclosure. As shown in FIG. 7, the apparatus includes: a determination module 71, an obtaining module 72, a processing module 73, and a generation module 74. The determination module 71 is configured to determine at least one piece of media content to be recommended. The obtaining module 72 is configured to obtain, for each piece of media content, basic information corresponding to the piece of media content, and obtain at least one type of interactive content generated based on the piece of media content. The processing module 73 is configured to generate, based on the basic information corresponding to each piece of media content and the at least one type of interactive content, recommended content corresponding to the piece of media content, wherein the recommended content includes a recommended image and a recommended text. The generation module 74 is configured to generate target recommended content based on the recommended content corresponding to each piece of media content, and post the target recommended content.

Further, on the basis of any one of the above embodiments, the processing module is configured to: generate, for each piece of media content and based on the basic information corresponding to the piece of media content, a recommended image associated with the piece of media content; generate, based on the basic information corresponding to the piece of media content and the at least one type of interactive content, a recommended text associated with the piece of media content; and generate, based on the recommended image and the recommended text, recommended content corresponding to the piece of media content.

Further, on the basis of any one of the above embodiments, the processing module is configured to: obtain the basic information from preset parameters associated with the piece of media content, wherein the basic information includes one or more of a content title, a content parameter, introduction information, and a cover image; and input the basic information into a predetermined image generation model to obtain a recommended image output by the image generation model, wherein the recommended image includes one or more of the content title, the content parameter, the introduction information, and the cover image, and a color of the recommended image matches that of the cover image.

Further, on the basis of any one of the above embodiments, the processing module is configured to: input, for each piece of media content, the basic information associated with the piece of media content and the at least one type of interactive content into a predetermined text generation model, to obtain a recommended text generated by the text generation model.

Further, on the basis of any one of the above embodiments, the obtaining module is configured to: obtain, from preset parameters associated with the piece of media content, introduction information and/or classification label information associated with the piece of media content, and determine the introduction information and/or classification label information as the basic information; and perform, based on a preset filtering condition, a filter operation on at least one type of interactive data associated with the piece of media content to obtain the at least one type of interactive information.

Further, on the basis of any one of the above embodiments, the interactive data includes at least one piece of content marking data generated by a user for at least part of the piece of media content. The processing module is configured to: determine a number of historical views corresponding to each piece of content marking data; and determine, as the interactive information, a piece of content marking data having a number of historical views greater than a preset number threshold from the at least one piece of content marking data.

Further, on the basis of any one of the above embodiments, the interactive data includes a plurality of pieces of image and text review data posted by a plurality of historical users for the piece of media content. The processing module is configured to: perform, by using a predetermined text recognition model, a filter operation on a plurality pieces of image and text review data satisfying a first preset condition in the interactive data to obtain a plurality of pieces of first interactive data, wherein the first preset condition includes an amount of data included in the image and text review data satisfying a preset data amount condition, and the image and text review data does not include negative emotional content; determine an association parameter corresponding to each piece of first interactive data, and perform a filter operation on the plurality of pieces of first interactive data based on a preset interaction condition and the association parameter to obtain a plurality of pieces of second interactive data, wherein the association parameters include data amount information, an interaction parameter, and a browsing parameter of the first interactive data; and perform a filter operation on the plurality of pieces of second interactive data by using a preset filtering word set to obtain the interactive information.

Further, on the basis of any one of the above embodiments, the filtering word set includes a positive word subset and a negative word subset. The processing module is configured to: perform a filtering-out operation on pieces of second interactive data including a word in the negative word subset in the plurality of pieces of second interactive data to obtain a plurality of pieces of filtered second interactive data; and determine, as the interactive information, a piece of second interactive data including a word in the positive word subset in the plurality of pieces of filtered second interactive data.

Further, on the basis of any one of the above embodiments, the generation module is configured to: determine a determination order corresponding to the at least one piece of media content; perform, based on the determination order, a sorting operation on the recommended images associated with the at least one piece of media content to obtain the sorted recommended images; display the sorted recommended images in a predetermined first display area; and perform, based on the determination order, a splicing operation on the recommended text corresponding to the at least one piece of media content to obtain spliced recommended texts; and display the spliced recommended texts in a predetermined second display area to obtain the target recommended content.

Further, on the basis of any one of the above embodiments, the apparatus further includes: a display module configured to display, in a display area associated with each of recommended images, a trigger control corresponding to the piece of media content associated with the recommended image, wherein the trigger control is configured to display the piece of media content in response to a trigger operation of the user after the target recommended content is posted.

Further, on the basis of any one of the above embodiments, the apparatus further includes: a display module configured to display, for a recommended text corresponding to each piece of media content in the spliced recommended texts, and a trigger control corresponding to the piece of media content in a display area associated with the recommended text, wherein the trigger control is configured to display the piece of media content in response to a trigger operation of the user after the target recommended content is posted.

Further, on the basis of any one of the above embodiments, the apparatus further includes: an obtaining module configured to obtain a target image determined by a user; and the obtaining module configured to display the target image before the sorted recommended image.

Further, on the basis of any one of the above embodiments, the apparatus further includes: an obtaining module configured to obtain content of editing determined by the user based on the recommended content; and an editing module configured to perform an editing operation on the recommended content based on the content of editing to obtain edited recommended content. The generation module is configured to: generate the target recommended content based on each piece of edited recommended content.

The device provided in this embodiment may be configured to perform the technical solution of the above method embodiment. The implementation principle and technical effects thereof are similar, and are not described herein again in this embodiment.

To implement the above embodiments, an embodiment of the present disclosure further provides a computer-readable storage medium storing computer-executable instructions that, when executed by a processor, cause the recommended content generation method according to any one of the above embodiments to be implemented.

To implement the above embodiments, an embodiment of the present disclosure further provides a computer program product including a computer program that, when executed by a processor, causes the recommended content generation method according to any one of the above embodiments to be implemented.

To implement the above embodiments, an embodiment of the present disclosure further provides an electronic device. The electronic device includes: a processor and a memory, where
the memory stores computer-executable instructions; and
the processor executes the computer-executable instructions stored in the memory, to cause the processor to perform the recommended content generation method according to any one of the above embodiments.

FIG. 8 is a schematic diagram of a structure of an electronic device according to an embodiment of the present disclosure. The electronic device 800 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 8 is merely an example, and shall not impose any limitation on the function and scope of use of the embodiments of the present disclosure.

As shown in FIG. 8, the electronic device 800 may include a processing apparatus (e.g., a central processing unit or a graphics processing unit) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to one another through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, wherein the computer program includes program code for performing the method shown in the flowchart. In such an embodiment, the computer program may be downloaded and installed from a network through the communication apparatus 809, installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, wherein the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to a first aspect, according to one or more embodiments of the present disclosure, a recommended content generation method is provided. The method includes:
determining at least one piece of media content to be recommended;
obtaining, for each piece of media content, basic information corresponding to the piece of media content, and obtaining at least one type of interactive content generated based on the piece of media content;
generating, based on the basic information corresponding to each piece of media content and the at least one type of interactive content, recommended content corresponding to the piece of media content, wherein the recommended content includes a recommended image and a recommended text; and
generating target recommended content based on the recommended content corresponding to each piece of media content, and posting the target recommended content.

According to one or more embodiments of the present disclosure, generating, based on the basic information corresponding to each piece of media content and the at least one type of interactive content, the recommended content corresponding to the piece of media content includes:
generating, for each piece of media content and based on the basic information corresponding to the piece of media content, a recommended image associated with the piece of media content;
generating, based on the basic information corresponding to the piece of media content and the at least one type of interactive content, a recommended text associated with the piece of media content; and
generating, based on the recommended image and the recommended text, recommended content corresponding to the piece of media content.

According to one or more embodiments of the present disclosure, obtaining the basic information corresponding to the piece of media content includes:
obtaining the basic information from preset parameters associated with the piece of media content, wherein the basic information includes one or more of a content title, a content parameter, introduction information, and a cover image; and
generating, based on the basic information corresponding to the piece of media content, the recommended image associated with the piece of media content includes:
inputting the basic information into a predetermined image generation model to obtain a recommended image output by the image generation model, wherein the recommended image includes one or more of the content title, the content parameter, the introduction information, and the cover image, and a color of the recommended image matches that of the cover image.

According to one or more embodiments of the present disclosure, generating, based on the basic information corresponding to the piece of media content and the at least one type of interactive content, the recommended text associated with the piece of media content includes:
inputting, for each piece of media content, the basic information associated with the piece of media content and the at least one type of interactive content into a predetermined text generation model, to obtain a recommended text generated by the text generation model.

According to one or more embodiments of the present disclosure, obtaining the basic information corresponding to the piece of media content, and obtaining the at least one type of interactive content generated based on the piece of media content includes:
obtaining, from preset parameters associated with the piece of media content, introduction information and/or classification label information associated with the piece of media content, and determining the introduction information and/or classification label information as the basic information; and
performing, based on a preset filtering condition, a filter operation on at least one type of interactive data associated with the piece of media content to obtain the at least one type of interactive information.

According to one or more embodiments of the present disclosure, the interactive data includes at least one piece of content marking data generated by a user for at least part of the piece of media content; and
performing, based on the preset filtering condition, the filter operation on the at least one type of interactive data associated with the piece of media content to obtain the at least one type of interactive information includes:
determining a number of historical views corresponding to each piece of content marking data; and
determining, as the interactive information, a piece of content marking data having a number of historical views greater than a preset number threshold from the at least one piece of content marking data.

According to one or more embodiments of the present disclosure, the interactive data includes a plurality of pieces of image and text review data posted by a plurality of historical users for the piece of media content; and
performing, based on the preset filtering condition, the filter operation on the at least one type of interactive data associated with the piece of media content to obtain the at least one type of interactive information includes:
performing, by using a predetermined text recognition model, a filter operation on a plurality pieces of image and text review data satisfying a first preset condition in the interactive data to obtain a plurality of pieces of first interactive data, wherein the first preset condition includes an amount of data included in the image and text review data satisfying a preset data amount condition, and the image and text review data does not include negative emotional content;
determining an association parameter corresponding to each piece of first interactive data, and performing a filter operation on the plurality of pieces of first interactive data based on a preset interaction condition and the association parameter to obtain a plurality of pieces of second interactive data, wherein the association parameter includes data amount information, an interaction parameter, and a browsing parameter of the first interactive data; and
performing a filter operation on the plurality of pieces of second interactive data by using a preset filtering word set to obtain the interactive information.

According to one or more embodiments of the present disclosure, the filtering word set includes a positive word subset and a negative word subset; and
performing the filter operation on the plurality of pieces of second interactive data by using the preset filtering word set to obtain the interactive information includes:
performing a filtering-out operation on pieces of second interactive data including a word in the negative word subset in the plurality of pieces of second interactive data to obtain a plurality of pieces of filtered second interactive data; and
determining, as the interactive information, a piece of second interactive data including a word in the positive word subset in the plurality of pieces of filtered second interactive data.

According to one or more embodiments of the present disclosure, generating the target recommended content based on the recommended content corresponding to each piece of media content includes:
determining a determination order corresponding to the at least one piece of media content;
performing, based on the determination order, a sorting operation on the recommended images associated with the at least one piece of media content to obtain the sorted recommended images;
displaying the sorted recommended images in a predetermined first display area;
performing, based on the determination order, a splicing operation on the recommended text corresponding to the at least one piece of media content to obtain spliced recommended texts; and
displaying the spliced recommended texts in a predetermined second display area to obtain the target recommended content.

According to one or more embodiments of the present disclosure, after generating the target recommended content based on the recommended content corresponding to each piece of media content, the method further includes:
displaying, in a display area associated with each of recommended images, a trigger control corresponding to the piece of media content associated with the recommended image, wherein the trigger control is configured to display the piece of media content in response to a trigger operation of the user after the target recommended content is posted.

According to one or more embodiments of the present disclosure, after performing, based on the determination order, the splicing operation on the recommended text corresponding to the at least one piece of media content to obtain the spliced recommended texts, the method further includes:
displaying, for a recommended text corresponding to each piece of media content in the spliced recommended texts, a trigger control corresponding to the piece of media content in a display area associated with the recommended text, wherein the trigger control is configured to display the piece of media content in response to a trigger operation of the user after the target recommended content is posted.

According to one or more embodiments of the present disclosure, the method further includes:
obtaining a target image determined by a user; and
displaying the target image before the sorted recommended image.

According to one or more embodiments of the present disclosure, after generating, based on the basic information corresponding to each piece of media content and the at least one type of interactive content, the recommended content corresponding to the piece of media content, the method further includes:
obtaining content of editing determined by the user based on the recommended content; and
performing an editing operation on the recommended content based on the content of editing to obtain edited recommended content; and
generating the target recommended content based on the recommended content corresponding to each piece of media content includes:
generating the target recommended content based on each piece of edited recommended content.

According to a second aspect, according to one or more embodiments of the present disclosure, a recommended content generation apparatus is provided. The apparatus includes:
a determination module configured to determine at least one piece of media content to be recommended;
an obtaining module configured to obtain, for each piece of media content, basic information corresponding to the piece of media content, and obtain at least one type of interactive content generated based on the piece of media content;
a processing module configured to generate, based on the basic information corresponding to each piece of media content and the at least one type of interactive content, recommended content corresponding to the piece of media content, wherein the recommended content includes a recommended image and a recommended text; and
a generation module configured to generate target recommended content based on the recommended content corresponding to each piece of media content, and post the target recommended content.

According to one or more embodiments of the present disclosure, the processing module is configured to:
generate, for each piece of media content and based on the basic information corresponding to the piece of media content, a recommended image associated with the piece of media content;
generate, based on the basic information corresponding to the piece of media content and the at least one type of interactive content, a recommended text associated with the piece of media content; and
generate, based on the recommended image and the recommended text, recommended content corresponding to the piece of media content.

According to one or more embodiments of the present disclosure, the processing module is configured to:
obtain the basic information from preset parameters associated with the piece of media content, wherein the basic information includes one or more of a content title, a content parameter, introduction information, and a cover image; and
input the basic information into a predetermined image generation model to obtain a recommended image output by the image generation model, wherein the recommended image includes one or more of the content title, the content parameter, the introduction information, and the cover image, and a color of the recommended image matches that of the cover image.

According to one or more embodiments of the present disclosure, the processing module is configured to:
input, for each piece of media content, the basic information associated with the piece of media content and the at least one type of interactive content into a predetermined text generation model, to obtain a recommended text generated by the text generation model.

According to one or more embodiments of the present disclosure, the obtaining module is configured to:
obtain, from preset parameters associated with the piece of media content, introduction information and/or classification label information associated with the piece of media content, and determine the introduction information and/or classification label information as the basic information; and
perform, based on a preset filtering condition, a filter operation on at least one type of interactive data associated with the piece of media content to obtain the at least one type of interactive information.

According to one or more embodiments of the present disclosure, the interactive data includes at least one piece of content marking data generated by a user for at least part of the piece of media content; and

The processing module is configured to:
determine a number of historical views corresponding to each piece of content marking data; and
determine, as the interactive information, a piece of content marking data having a number of historical views greater than a preset number threshold from the at least one piece of content marking data.

According to one or more embodiments of the present disclosure, the interactive data includes a plurality of pieces of image and text review data posted by a plurality of historical users for the piece of media content; and

The processing module is configured to:
perform, by using a predetermined text recognition model, a filter operation on a plurality pieces of image and text review data satisfying a first preset condition in the interactive data to obtain a plurality of pieces of first interactive data, wherein the first preset condition includes an amount of data included in the image and text review data satisfying a preset data amount condition, and the image and text review data does not include negative emotional content;
determine an association parameter corresponding to each piece of first interactive data, and perform a filter operation on the plurality of pieces of first interactive data based on a preset interaction condition and the association parameter to obtain a plurality of pieces of second interactive data, wherein the association parameter includes data amount information, an interaction parameter, and a browsing parameter of the first interactive data; and
perform a filter operation on the plurality of pieces of second interactive data by using a preset filtering word set to obtain the interactive information.

According to one or more embodiments of the present disclosure, the filtering word set includes a positive word subset and a negative word subset; and
the processing module is configured to:
perform a filtering-out operation on pieces of second interactive data including a word in the negative word subset in the plurality of pieces of second interactive data to obtain a plurality of pieces of filtered second interactive data; and
determine, as the interactive information, second interactive data included in the plurality of pieces of filtered second interactive data including a word in the positive word subset.

According to one or more embodiments of the present disclosure, the generation module is configured to:
determine a determination order corresponding to the at least one piece of media content;
perform, based on the determination order, a sorting operation on the recommended images associated with the at least one piece of media content to obtain the sorted recommended images;
display the sorted recommended images in a predetermined first display area;
perform, based on the determination order, a splicing operation on the recommended text corresponding to the at least one piece of media content to obtain spliced recommended texts; and
display the spliced recommended texts in a predetermined second display area to obtain the target recommended content.

According to one or more embodiments of the present disclosure, the apparatus further includes:
a display module configured to display, in a display area associated with each of recommended images, a trigger control corresponding to the piece of media content associated with the recommended image, wherein the trigger control is configured to display the piece of media content in response to a trigger operation of the user after the target recommended content is posted.

According to one or more embodiments of the present disclosure, the apparatus further includes:
a display module configured to display, for a recommended text corresponding to each piece of media content in the spliced recommended texts, a trigger control corresponding to the piece of media content in a display area associated with the recommended text, wherein the trigger control is configured to display the piece of media content in response to a trigger operation of the user after the target recommended content is posted.

According to one or more embodiments of the present disclosure, the apparatus further includes:
an obtaining module configured to obtain a target image determined by a user; and
the obtaining module configured to display the target image before the sorted recommended image.

According to one or more embodiments of the present disclosure, the apparatus further includes:
obtaining content of editing determined by the user based on the recommended content; and
performing an editing operation on the recommended content based on the content of editing to obtain edited recommended content; and
the generation module is configured to:
generate the target recommended content based on each piece of edited recommended content.

According to a third aspect, according to one or more embodiments of the present disclosure, tan electronic device is provided. The electronic device includes: at least one processor and a memory.
the memory stores computer-executable instructions; and
the at least one processor executes the computer-executable instructions stored in the memory, to cause the at least one processor to perform the recommended content generation method according to the first aspect and various possible designs of the first aspect.

According to a fourth aspect, according to one or more embodiments of the present disclosure, a computer-readable storage medium is provided. The computer-readable storage medium has stored therein computer-executable instructions that, when executed by a processor, cause the recommended content generation method according to the first aspect and various possible designs of the first aspect to be implemented.

According to a fifth aspect, according to one or more embodiments of the present disclosure, a computer program product including a computer program is provided. When the computer program is executed by a processor, the recommended content generation method according to the first aspect and various possible designs of the first aspect is implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A recommended content generation method, comprising:
determining at least one piece of media content to be recommended;
obtaining, for each piece of media content, basic information corresponding to the piece of media content, and obtaining at least one type of interactive content generated based on the piece of media content;
generating, based on the basic information corresponding to each piece of media content and the at least one type of interactive content, recommended content corresponding to the piece of media content, wherein the recommended content comprises a recommended image and a recommended text; and
generating target recommended content based on the recommended content corresponding to each piece of media content, and posting the target recommended content.

2. The method according to claim 1, wherein generating, based on the basic information corresponding to each piece of media content and the at least one type of interactive content, the recommended content corresponding to the piece of media content comprises:
generating, for each piece of media content and based on the basic information corresponding to the piece of media content, a recommended image associated with the piece of media content;
generating, based on the basic information corresponding to the piece of media content and the at least one type of interactive content, a recommended text associated with the piece of media content; and
generating, based on the recommended image and the recommended text, the recommended content corresponding to the piece of media content.

3. The method according to claim 2, wherein obtaining the basic information corresponding to the piece of media content comprises:
obtaining the basic information from preset parameters associated with the piece of media content, wherein the basic information comprises one or more of a content title, a content parameter, introduction information, and a cover image; and
generating, based on the basic information corresponding to the piece of media content, the recommended image associated with the piece of media content comprises:
inputting the basic information into a predetermined image generation model to obtain a recommended image output by the image generation model, wherein the recommended image comprises one or more of the content title, the content parameter, the introduction information, and the cover image, and a color of the recommended image matches that of the cover image.

4. The method according to claim 2, wherein generating, based on the basic information corresponding to the piece of media content and the at least one type of interactive content, the recommended text associated with the piece of media content comprises:
inputting, for each piece of media content, the basic information associated with the piece of media content and the at least one type of interactive content into a predetermined text generation model, to obtain a recommended text generated by the text generation model.

5. The method according to claim 1, wherein obtaining the basic information corresponding to the piece of media content, and obtaining the at least one type of interactive content generated based on the piece of media content comprises:
obtaining, from preset parameters associated with the piece of media content, introduction information and/or classification label information associated with the piece of media content, and determining the introduction information and/or classification label information as the basic information; and
performing, based on a preset filtering condition, a filter operation on at least one type of interactive data associated with the piece of media content to obtain the at least one type of interactive information.

6. The method according to claim 5, wherein the interactive data comprises at least one piece of content marking data generated by a user for at least part of the piece of media content; and
performing, based on the preset filtering condition, the filter operation on the at least one type of interactive data associated with the piece of media content to obtain the at least one type of interactive information comprises:
determining a number of historical views corresponding to each piece of content marking data; and
determining, as the interactive information, a piece of content marking data having a number of historical views greater than a preset number threshold from the at least one piece of content marking data.

7. The method according to claim 5, wherein the interactive data comprises a plurality of pieces of image and text review data posted by a plurality of historical users for the piece of media content; and
performing, based on the preset filtering condition, the filter operation on the at least one type of interactive data associated with the piece of media content to obtain the at least one type of interactive information comprises:
performing, by using a predetermined text recognition model, a filter operation on a plurality pieces of image and text review data satisfying a first preset condition in the interactive data to obtain a plurality of pieces of first interactive data, wherein the first preset condition comprises an amount of data comprised in the image and text review data satisfying a preset data amount condition, and the image and text review data not comprising negative emotional content;
determining an association parameter corresponding to each piece of first interactive data, and performing a filter operation on the plurality of pieces of first interactive data based on a preset interaction condition and the association parameter to obtain a plurality of pieces of second interactive data, wherein the association parameter comprises data amount information, an interaction parameter, and a browsing parameter of the first interactive data; and
performing a filter operation on the plurality of pieces of second interactive data by a preset filtering word set to obtain the interactive information.

8. The method according to claim 7, wherein the filtering word set comprises a positive word subset and a negative word subset; and
performing the filter operation on the plurality of pieces of second interactive data by the preset filtering word set to obtain the interactive information comprises:
performing a filtering-out operation on pieces of second interactive data comprising a word in the negative word subset in the plurality of pieces of second interactive data, to obtain a plurality of pieces of filtered second interactive data; and
determining, as the interactive information, a piece of second interactive data comprising a word in the positive word subset in the plurality of pieces of filtered second interactive data.

9. The method according to claim 1, wherein generating the target recommended content based on the recommended content corresponding to each piece of media content comprises:
determining a determination order corresponding to the at least one piece of media content;
performing, based on the determination order, a sorting operation on the recommended images associated with the at least one piece of media content to obtain the sorted recommended images;
displaying the sorted recommended images in a predetermined first display area;
performing, based on the determination order, a splicing operation on the recommended text corresponding to the at least one piece of media content to obtain spliced recommended texts; and
displaying the spliced recommended texts in a predetermined second display area to obtain the target recommended content.

10. The method according to claim 9, wherein after generating the target recommended content based on the recommended content corresponding to each piece of media content, the method further comprises:
displaying, in a display area associated with each recommended image, a trigger control corresponding to the piece of media content associated with the recommended image, wherein the trigger control is configured to display the piece of media content in response to a trigger operation of the user after the target recommended content is posted.

11. The method according to claim 9, wherein after performing, based on the determination order, the splicing operation on the recommended text corresponding to the at least one piece of media content to obtain the spliced recommended texts, the method further comprises:
displaying, for a recommended text corresponding to each piece of media content in the spliced recommended texts, a trigger control corresponding to the piece of media content in a display area associated with the recommended text, wherein the trigger control is configured to display the piece of media content in response to a trigger operation of the user after the target recommended content is posted.

12. The method according to claim 9, wherein the method further comprises:
obtaining a target image determined by the user; and
displaying the target image before the sorted recommended image.

13. The method according to claim 1, wherein after generating, based on the basic information corresponding to each piece of media content and the at least one type of interactive content, the recommended content corresponding to the piece of media content, the method further comprises:
obtaining content of editing determined by the user based on the recommended content; and
performing an editing operation on the recommended content based on the content of editing, to obtain edited recommended content; and
generating the target recommended content based on the recommended content corresponding to each piece of media content comprises:
generating the target recommended content based on each piece of edited recommended content.

14. An electronic device, comprising: a processor and a memory, wherein
the memory stores computer-executable instructions; and
the processor executes the computer-executable instructions stored in the memory, to cause the processor to perform a recommended content generation method comprising:
determining at least one piece of media content to be recommended;
obtaining, for each piece of media content, basic information corresponding to the piece of media content, and obtaining at least one type of interactive content generated based on the piece of media content;
generating, based on the basic information corresponding to each piece of media content and the at least one type of interactive content, recommended content corresponding to the piece of media content, wherein the recommended content comprises a recommended image and a recommended text; and
generating target recommended content based on the recommended content corresponding to each piece of media content, and posting the target recommended content.

15. The electronic device according to claim 14, wherein generating, based on the basic information corresponding to each piece of media content and the at least one type of interactive content, the recommended content corresponding to the piece of media content comprises:
generating, for each piece of media content and based on the basic information corresponding to the piece of media content, a recommended image associated with the piece of media content;
generating, based on the basic information corresponding to the piece of media content and the at least one type of interactive content, a recommended text associated with the piece of media content; and
generating, based on the recommended image and the recommended text, the recommended content corresponding to the piece of media content.

16. The electronic device according to claim 15, wherein obtaining the basic information corresponding to the piece of media content comprises:
obtaining the basic information from preset parameters associated with the piece of media content, wherein the basic information comprises one or more of a content title, a content parameter, introduction information, and a cover image; and
generating, based on the basic information corresponding to the piece of media content, the recommended image associated with the piece of media content comprises:
inputting the basic information into a predetermined image generation model to obtain a recommended image output by the image generation model, wherein the recommended image comprises one or more of the content title, the content parameter, the introduction information, and the cover image, and a color of the recommended image matches that of the cover image.

17. The electronic device according to claim 15, wherein generating, based on the basic information corresponding to the piece of media content and the at least one type of interactive content, the recommended text associated with the piece of media content comprises:
inputting, for each piece of media content, the basic information associated with the piece of media content and the at least one type of interactive content into a predetermined text generation model, to obtain a recommended text generated by the text generation model.

18. The electronic device according to claim 14, wherein obtaining the basic information corresponding to the piece of media content, and obtaining the at least one type of interactive content generated based on the piece of media content comprises:
obtaining, from preset parameters associated with the piece of media content, introduction information and/or classification label information associated with the piece of media content, and determining the introduction information and/or classification label information as the basic information; and
performing, based on a preset filtering condition, a filter operation on at least one type of interactive data associated with the piece of media content to obtain the at least one type of interactive information.

19. The electronic device according to claim 18, wherein the interactive data comprises at least one piece of content marking data generated by a user for at least part of the piece of media content; and
performing, based on the preset filtering condition, the filter operation on the at least one type of interactive data associated with the piece of media content to obtain the at least one type of interactive information comprises:
determining a number of historical views corresponding to each piece of content marking data; and
determining, as the interactive information, a piece of content marking data having a number of historical views greater than a preset number threshold from the at least one piece of content marking data.

20. A non-transitory computer-readable storage medium having stored therein computer-executable instructions, wherein that the computer-executable instructions, when being executed by a processor, implement a recommended content generation method comprising:
determining at least one piece of media content to be recommended;
obtaining, for each piece of media content, basic information corresponding to the piece of media content, and obtaining at least one type of interactive content generated based on the piece of media content;
generating, based on the basic information corresponding to each piece of media content and the at least one type of interactive content, recommended content corresponding to the piece of media content, wherein the recommended content comprises a recommended image and a recommended text; and
generating target recommended content based on the recommended content corresponding to each piece of media content, and posting the target recommended content.
